(19) United States
(12) Patent Application Publication
(10) Pub. No.: US 2008/0315601 A1
(43) Pub. Date: Dec. 25, 2008

(54) Post hole digger

(75) Inventors: Daniel J. Libscomb, Prairie du Sac, WI (US); Jason Crowell, Madison, WI (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/820,797

(22) Filed: Jun. 21, 2007

(51) Int. Cl. B25F 1/04

(52) U.S. Cl. 294/50.8

(57) ABSTRACT

A post hole digger for producing a hole in the ground, including a first shaft pivotally coupled to a second shaft by a pivot joint defining a pivot axis. A first blade is coupled to the first shaft, the first blade extending from the first shaft toward the second shaft on one side of the pivot axis, and a second blade is coupled to the second shaft, the second blade extending from the second shaft toward the first shaft on an opposite side of the pivot axis.

### BACKGROUND

The present invention generally relates to post hole diggers. The present invention more specifically relates to a post hole digger that enables a user to conveniently produce a vertical hole in the ground with minimal interference between the post hole digger and the sides of the vertical hole. The present invention more particularly relates to a post hole digger having offset blades.

It is generally known to provide a post hole digger for digging holes within the earth for placement of a post therein. Traditional post hole diggers usually include two generally symmetric and concave blades that face one another to form a generally cylindrical region about six inches in diameter. The blades are pivotally connected to one another proximate the top portion of the blades. Extending from the top central area of each generally symmetrical blade is a fixture (e.g. cap or neck) supporting a shaft handle extending approximately four feet in height. The blades are spaced apart from one another such that each shaft is proximate the inner surface of each of the blades. By thrusting the blades into the ground, the earth is secured between the blades by moving the upper end of the handles away from one another forcing the blades to pivot about the pivot toward one another.

As the hole becomes deeper, the pivoting motion of the blades results in the shafts contacting the edge of the hole proximate the top of the hole. This minimizes the pivoting motion of the blades and thereby reduces the amount of dirt that can be pulled out with each pivoting motion of the shafts. As a result, a user is often forced to widen the width of the hole in order to accommodate the shafts. This can result both in excess effort from the user, as well as an increased use of cement and/or other type of filling for the hole.

Accordingly, it would be advantageous to provide a post hole digger that allows for full pivoting of the blades relative to one another while minimizing the contact between the shafts and the upper edge of the hole. It would also be advantageous to provide a post hole digger that enables a user to dig deeper post holes without having to increase the diameter of the hole opening as the depth of the hole increases. It would also be advantageous to provide a post hole digger that enables a user to close the blades of the post hole digger without having the handles or shafts wider than the diameter of the top of the hole. It would also be desirable to provide a post hole digger having shafts coupled to their respective blades in a laterally-offset manner. It would also be desirable to provide a post hole digger with blades having a neck region extending from one side of the blade to couple to a handle, with the opposite side of the blade extending toward the other shaft.

It would be advantageous to provide a post hole digger or the like of a type disclosed in the present application that provides any one or more of these or other advantageous features. The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### SUMMARY

One aspect of the invention relates to a post hole digger having a first shaft pivotally coupled to a second shaft by a pivot joint defining a pivot axis. A first blade is coupled to the first shaft, the first blade extending from the first shaft toward the second shaft on one side of the pivot axis, and a second blade is coupled to the second shaft, the second blade extending from the second shaft toward the first shaft on an opposite side of the pivot axis.

Another aspect of the invention relates to a post hole digger having a first shaft defining a first axis and a second shaft defining a second axis. A pivot joint couples the first shaft to the second shaft for pivotal movement of the shafts about a pivot axis between an open position and a closed position, and the first axis and the second axis and the pivot axis define a central plane when the shafts are in the open position. A first blade is coupled to the first shaft and disposed only on a first side of the central plane in the open position, and a second blade is coupled to the second shaft and disposed only on a second side of the central plane in the open position.

A further aspect of the invention relates to a post hole digger having a first substantially straight shaft coupled to a second substantially straight shaft by a pivot joint defining a pivot axis that intersects the first shaft and the second shaft. A first blade is coupled to the first shaft, and a second blade is coupled to the second shaft.

### BRIEF DESCRIPTION OF THE DRAWINGS

FIG. 1 is a front perspective view of a post hole digger according to an exemplary embodiment.

FIG. 2 is a side view of the post hole digger in an open position according to an exemplary embodiment.

FIG. 3 is a side view of the post hole digger in a closed position according to an exemplary embodiment.

FIG. 4 is a side view of the post hole digger according to an exemplary embodiment.

FIG. 5 is a top view of the post hole digger in an open position according to an exemplary embodiment.

FIG. 6 is a cross sectional view of the post hole digger of the exemplary embodiment along line 6-6 of FIG. 5.

FIG. 7 is a side view of an application of the post hole digger according to the exemplary embodiment.

FIG. 8 is a side view of an application of a conventional post hole digger.

### DETAILED DESCRIPTION

Before explaining a number of preferred, exemplary, and alternative embodiments of the invention in detail, it is to be understood that the invention is not limited to the details or methodology set forth in the following description or illustrated in the drawings. The invention is capable of other embodiments or being practiced or carried out in various ways. It is also to be understood that the phraseology and terminology employed herein is for the purpose of description and should not be regarded as limiting.

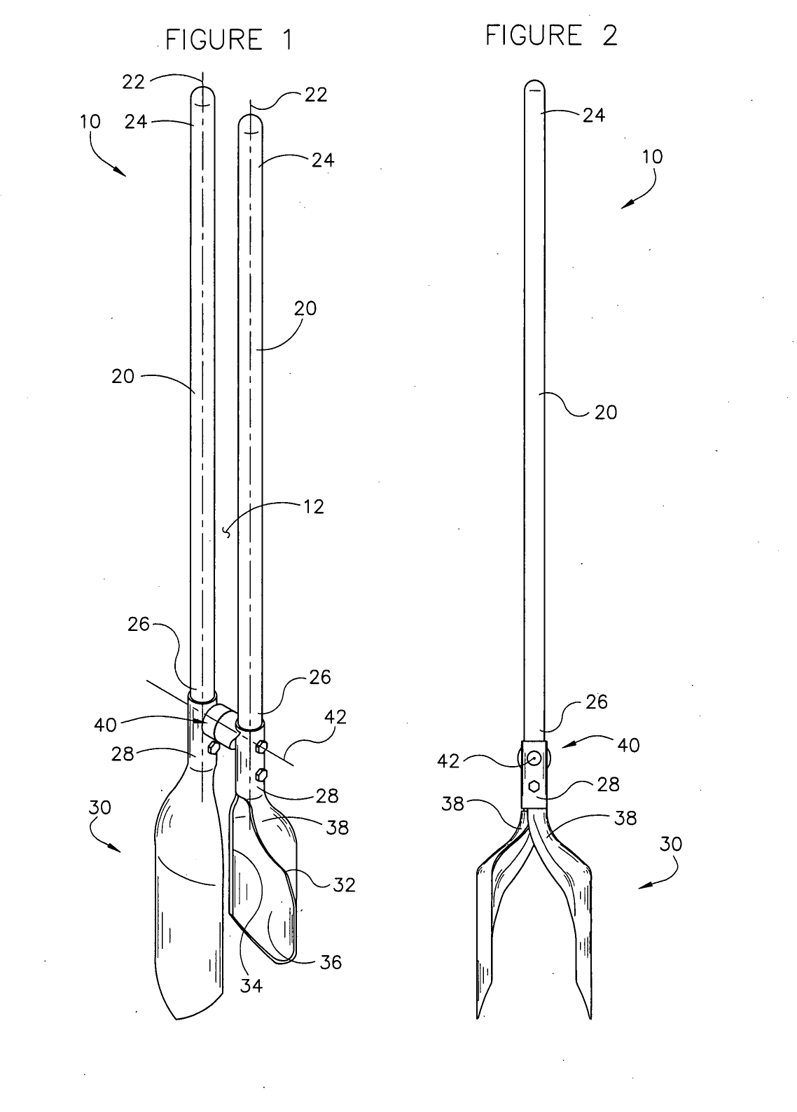

A system (shown as a post hole digger 10) for digging holes within the earth (e.g., for the placement of posts, fences, poles, etc.) is shown in FIG. 1 according to an exemplary embodiment. Post hole digger 10 includes a pair of offset blades that may be operated by a user to dig deeper, more uniform diameter post holes without having to widen the upper portion of the hole.

Referring to FIG. 1, post hole digger 10 includes a pair of shafts (shown as substantially straight shafts 20, each having a longitudinal axis 22) and a pair of asymmetric blades 30 attached to shafts 20 in an “offset” arrangement. Shafts 20 are pivotally attached to one another at a pivot connection 40. Each shaft 20 includes an upper grip 24, a pivot portion 26, and a lower end 28. As shown in FIGS. 1, 4 and 5, shafts 20 may be attached to one another by a pivot joint or pivot connection 40 at pivot portion 26 proximate the lower end 28. According to various alternative embodiments, shafts 20 may be attached by pivot connection 40 at any suitable point along shafts 20. The lower end 28 includes an engagement face or surface that is shown directly connected to a neck portion of each respective blade 30.

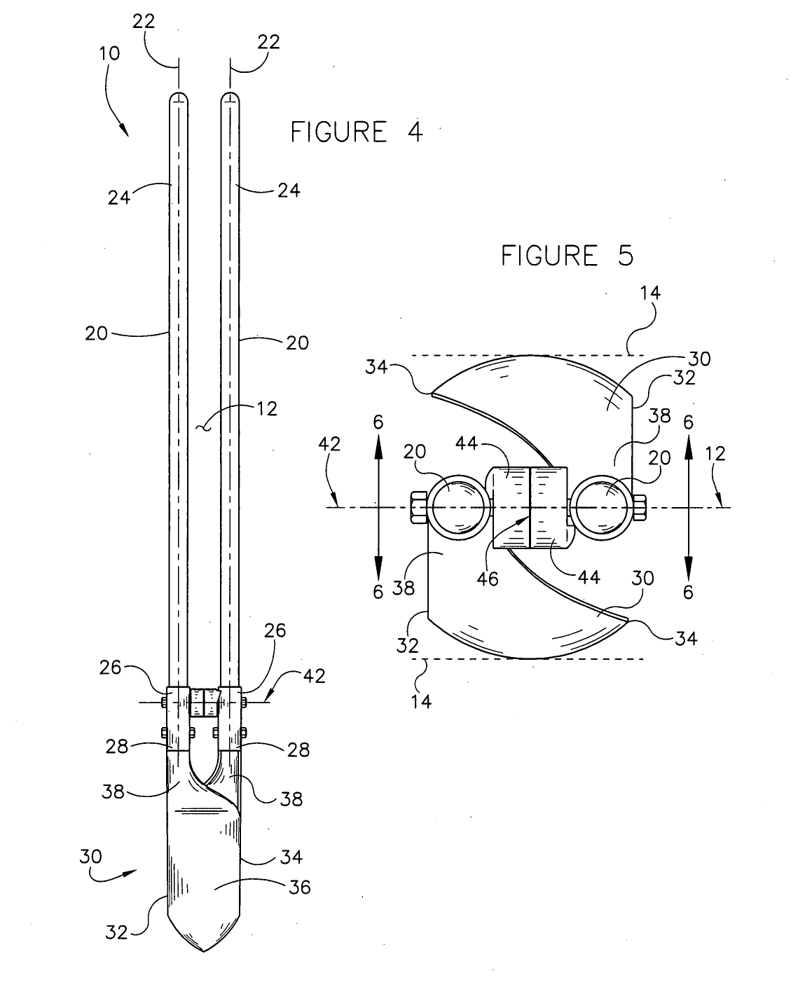

FIGS. 1, 2, 4 and 5 show the post hole digger 10 in a non-extended or stowed configuration (e.g., the blades 30 are in an open position). When in the open position, and as shown in FIGS. 2 and 4, the longitudinal axes 22 of shafts 20 are generally parallel and define a central plane 12 which also extends through a central pivot axis 42 of pivot connection 40. Upper grip 18 and blade 30 for each shaft 20 are both shown on the same respective side of plane 12.

Referring to the FIGS. 2 and 4, the blades are shown according to an exemplary embodiment. Blades 30 are shown to include a first side edge 32 and a second side edge 34 and a curved (e.g. concave, etc.) region 36 extending therebetween. The blades 30 are oriented with respect to the shafts 20 so that a tangent 14 to the curved region 36 is arranged generally parallel to pivot axis 42 (see FIG. 5). A neck region or neck portion 38 extends upwardly from the blade 30 proximate one of the side edges (i.e. in a laterally “offset” manner, and shown for example as first side edge 32 in FIGS. 4 and 5). The neck region 38 provides a transition structure for coupling each blade 30 to the lower end 28 of its respective shaft 20.

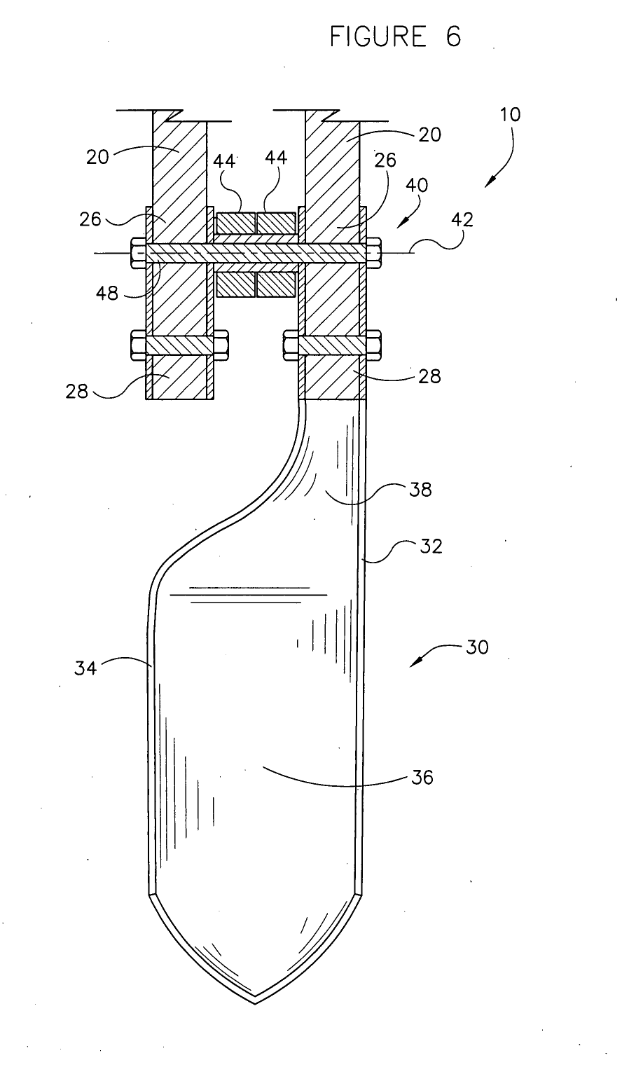

Referring to FIG. 5, with neck 38 of blade 30 coupled to one shaft 20 (e.g. by a suitable fastener or the like), the first side edge 32 of the blade is aligned proximate its shaft, and the curved region 36 extends toward the opposite shaft, so that the second side edge 34 is aligned proximate the opposite shaft, with each blade remaining substantially entirely on one side of the central plane 12, and the pivot axis 42. Referring further to the embodiment of FIGS. 6A-6B, the neck portion 38 is shown generally in the form of a partially cylindrical conduit that transitions asymmetrically from the curved region 36 of the blade 30 along one side 32 for attachment to an end region of a shaft. According to any exemplary embodiment, the blades may have any suitable shape for connection to the shafts in an “offset” manner.

According to an exemplary embodiment, the shafts 20 may be spaced approximately two to four inches apart from one another when in the open position as shown in FIG. 4. Of course the exact distance between the shafts may vary according to various exemplary embodiments. According to one exemplary embodiment, both of the shafts fit within a cylindrical plane defined by the shape of the blades 30.

Referring to FIG. 5 pivot connection 40 will be described in greater detail. Pivot connection 40 provides a pivot joint and defines a pivot axis 42, about which the shafts and the blades rotate between the open position and the closed position. Pivot axis 42 lies within central plane 12 (in the open position) and perpendicularly intersects the longitudinal axis 22 of each shaft 20 at the pivot portion 26. Pivot connection 40 includes a pair of bearings 44. Each bearing 44 includes a bearing surface 46, which may include either a coating or a separate material being corrosion resistant, non-rusting, and having a low coefficient of friction. A pivot pin 48 (shown for example as a rod or stud having threaded ends to receive opposing nuts) extends through the bearings 44 and the shafts 20 and includes a nut on each end to retain the pivot connection together as an assembly. Each bearing may also includes a pin extending therefrom that is received in a corresponding slot on the other bearing (not shown). This pin and slot arrangement serves as a “travel stop” and limits the rotation of the bearings relative to one another and as a result limits the rotation of the shafts and the blades. The slot allows the bearing to pivot a predefined angle from the vertical (e.g. in a range between approximately 10 and 35 degrees from the vertical, and more preferably about 22.5 degrees from the vertical). According to alternative embodiments, the bearings may be omitted and the shafts pivotally coupled to one another by pivot pin.

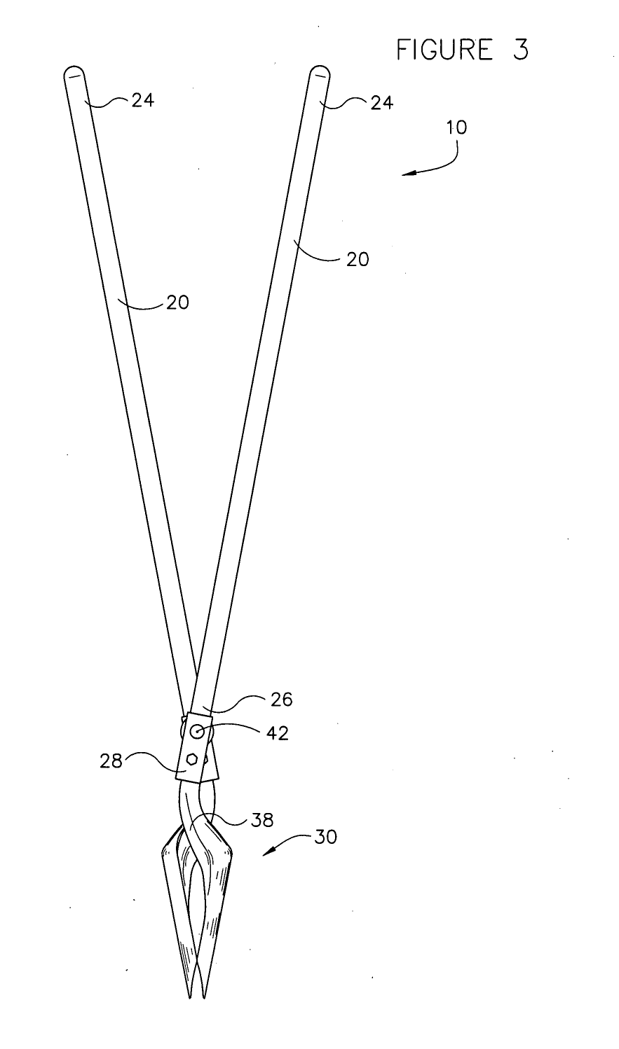

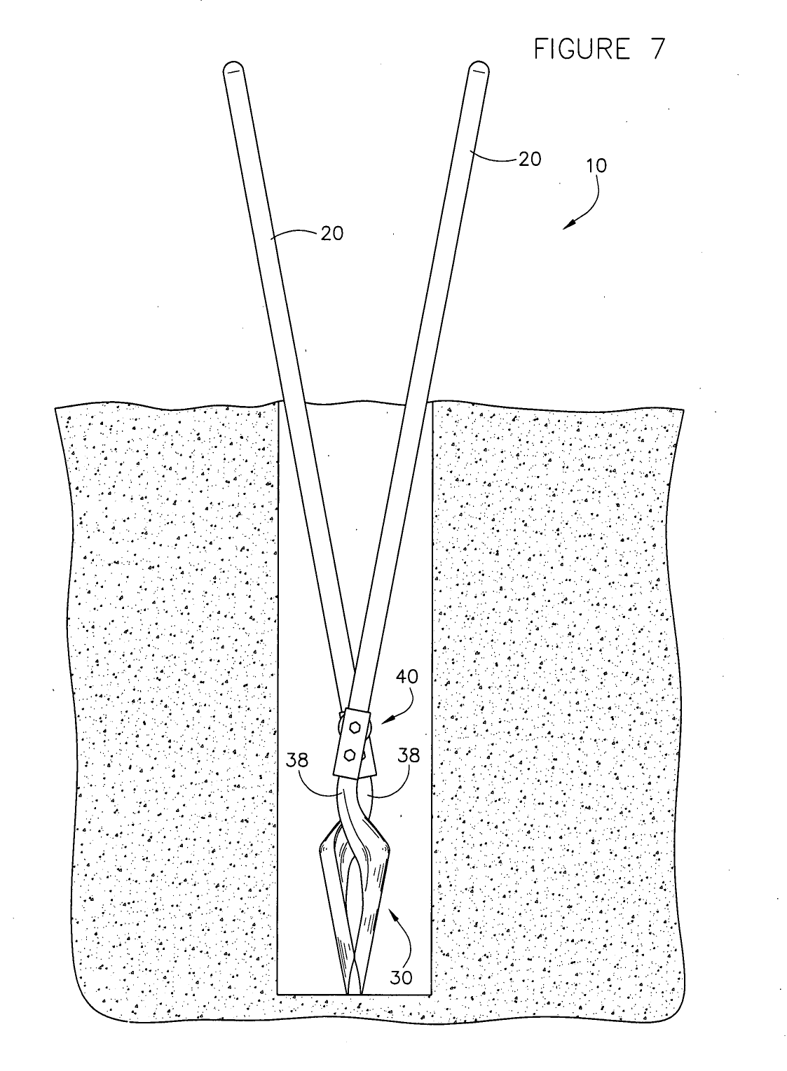

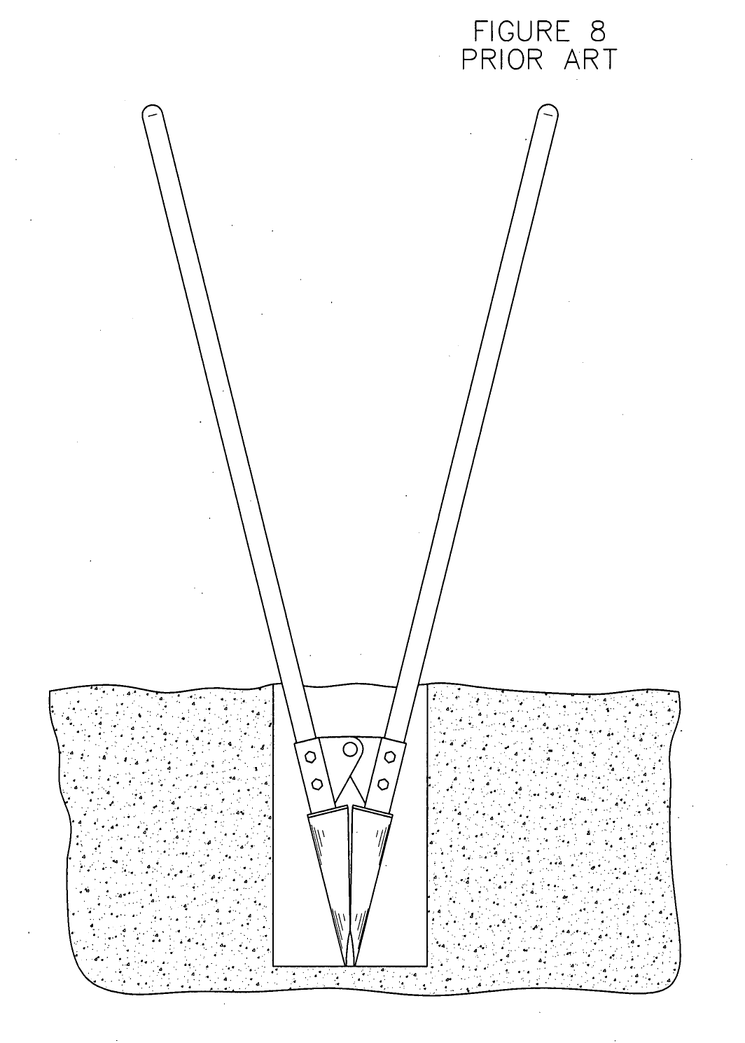

Referring to FIG. 7 post hole digger 10 is shown in a fully closed position (e.g., the post hole digger 10 is located within a hole in the ground). According to an exemplary embodiment, the asymmetric and offset blade configuration of post hole digger 10, along with the perpendicular intersection of the pivot axis with the longitudinal axes of the shafts, permits deeper penetration of the post hole digger (i.e. before the shafts contact the edges of the top of the hole), than is typically available with a conventional post hole digger as shown in FIG. 8. A user operates the post hole digger 10 by opening the post hole digger (i.e. moving the grips together into the position shown in FIGS. 1, 2, 4 and 7), digging the blades into the earth (e.g. at the bottom of a hole), closing the post hole digger (i.e. moving the grips away from one another as shown in FIG. 3), and then removing the blades from the hole with the soil captured between the blades, and then moving the grips toward one another so that shafts pivot about pivot axis 42 and blades 30 move apart from one another, thereby releasing the soil from between the blades 30.

According to various exemplary embodiments, the assemblies and components of the post hole digger may be constructed from various different materials. According to a preferred embodiment, the assemblies and components of the post hole digger may be constructed from materials that are durable, substantially non-corroding, and light weight. For example, a variety of plastics (e.g., high-impact), polymers, rubber, etc. may be used for construction or assembly of the grip. Using rubber or plastic offers several advantages including that the grip may be constructed in a variety of different colors, surface finishes, textures, opacity, etc. According to various exemplary embodiments, a variety of suitable materials may be used for other components (such as the shafts and blades) of the post hole digger, including metals, alloys, composites, aluminum, stainless steel, fiberglass, wood, etc. Further, various parts of the post hole digger may be constructed and assembled as a single integrally formed piece or may be constructed and assembled from multiple parts.

It is important to note that the construction and arrangement of the elements of the post hole digger as shown in the various embodiments is illustrative only. Although only a few embodiments of the present inventions have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, etc.) without materially departing from the novel teachings and advantages of the subject matter disclosed in this application. For example, the blades may have a neck region of any particular shape for connection to its shaft and may extending proximate either side of the blade. Accordingly, all such modifications are intended to be included within the scope of the present invention. The order or sequence of any process or method steps may be varied or re-sequenced according to alternative embodiments. In any claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions.

1. A post hole digger, comprising:
a first shaft pivotally coupled to a second shaft by a pivot joint defining a pivot axis;
a first blade having a inner face and an outer face bounded by a top and a bottom and a first side edge and a second side edge, the first blade coupled to the first shaft along the first side edge of the first blade; and
a second blade having a inner face and an outer face bounded by a top and a bottom and a first side edge and a second side edge, the second blade coupled to the second shaft along the first side edge of the second blade.

2. The post hole digger of claim 1, wherein the first side edge disposed proximate the first shaft, and the second side edge pf the first blade extend substantially parallel to the first shaft.

3. The post hole digger of claim 2, wherein the first side edge and the second side edge of the second blade extend substantially parallel to the second shaft.

4. The post hole digger of claim 1, wherein the first blade comprises a neck extending from the first side edge of the first blade to couple to the first shaft.

5. The post hole digger of claim 4, wherein the second blade comprises a neck extending from the first side edge of the second blade to couple to the second shaft.

6. The post hole digger of claim 1, wherein the pivot axis intersects a longitudinal axis of the first shaft and a longitudinal axis of the second shaft.

7. The post hole digger of claim 6, wherein the longitudinal axes and the pivot axis define a plane extending between the blades.

8. A post hole digger, comprising:
a first shaft defining a first axis;
a second shaft defining a second axis;
a pivot joint coupling the first shaft to the second shaft for pivotal movement of the shafts about a pivot axis between an open position and a closed position;
a first blade having a curved profile defining an arc with a first side edge and a second side edge on opposite ends of the arc and extending substantially parallel to the first axis, the first blade coupled to the first shaft proximate the first side edge of the first blade;
a second blade having a curved profile defining an arc with a first side edge and a second side edge on opposite ends of the arc and extending substantially parallel to the second axis, the second blade coupled to the second shaft proximate the first side edge of the second blade.

9. (canceled)

10. (canceled)

11. The post hole digger of claim 8, wherein the first blade comprises a neck extending proximate the first side edge of the first blade to couple to the first shaft.

12. The post hole digger of claim 11, wherein the second blade comprises a neck extending proximate a first side of the second blade to couple to the second shaft.

13. The post hole digger of claim 12, wherein the neck is transitioned asymmetrically into the curved profile of the blade.

14. The post hole digger of claim 8, wherein the curved profile of the first blade and the second blade each have a tangent that is substantially parallel to the plane.

15. A post hole digger, comprising:
a first substantially straight shaft coupled to a second substantially straight shaft by a pivot connection defining a pivot axis that intersects the first shaft and the second shaft;
a first blade having a profile defining a curve with a first side edge and a second side edge on opposite ends of the curve and extending substantially parallel to the first shaft, the first blade coupled to the first shaft proximate the first side edge; and
a second blade having a profile defining a curve with a first side edge and a second side edge on opposite ends of the curve and extending substantially parallel to the second shaft, the second blade coupled to the second shaft proximate the second side edge.

16. The post hole digger of claim 15, wherein the first blade comprises a neck extending from the first side edge of the first blade to couple to the first shaft.

17. The post hole digger of claim 16, wherein the second blade comprises a neck extending from the first side edge of the second blade to couple to the second shaft.

18. The post hole digger of claim 17, wherein the neck is transitioned asymmetrically into a curved region of the blade.

19. The post hole digger of claim 15, wherein the first blade and the second blade each comprise a curved region having a tangent that is substantially parallel to the pivot axis.
